(19) United States
(12) Patent Application Publication
(10) Pub. No.: US 2011/0119332 A1
(43) Pub. Date: May 19, 2011

(54) MOVEMENT ANIMATION METHOD AND APPARATUS

(75) Inventors: Steve Marshall, Reading (GB); Geroge Richard Alexander, Nottingham (GB); Rocco Localszo, Nottingham (GB); Paul Tempest, London (GB); Jonathan Green, Nottingham (GB); Malcolm Ian Clark, Wimbledon (GB)

(73) Assignee: CYBERSPORTS LIMITED, London (GB)

(21) Appl. No.: 12/774,528

(22) Filed: May 5, 2010

Related U.S. Application Data
(63) Continuation of application No. PCT/EP2008/065536, filed on Nov. 14, 2008.

(30) Foreign Application Priority Data
Nov. 14, 2007 (GB) 0722341.5

(51) Int. Cl. G06F 15/16

(52) U.S. Cl. 709/203

(57) ABSTRACT

The invention relates to methods and apparatus for movement animation of a user-controlled entity in a virtual environment. Entity tracking data is stored on a server in order to track movement of the entity in the virtual environment. A user may input a desired action for their entity via a client, which is transmitted from the client to the server. The server uses the received data to select an appropriate animation for the entity. The server then transmits data identifying the selected animation to the client, thus controlling animation of the entity on the client. By using animation data to simulate movement of the entity, along with keeping an accurate representation of the movement of the entity in the virtual environment, the server may control the entity accurately and therefore animation of the entity may be more realistic.

### FIELD OF THE INVENTION

The present invention relates to a method and apparatus for movement animation. In particular, the present invention relates to movement animation of a user-controlled entity.

### BACKGROUND OF THE INVENTION

In known server-based game systems, the server implements character movement as if the character were a simple point mass, moving along lines and curves as indicated by the user's controls. Animations used on a client cause the character's limbs to move as best as possible to give an appearance of realism in movement. However, this often results in ‘foot-sliding’ where the character's feet appear to slide across the ground, or awkward blending between animations.

For an immersive, action-intensive application such as a football game, such known systems do not provide a realistic look and feel to the gaming environment. For example, if a player makes a 180° turn with a ball at his feet, he makes a complex manoeuvre, quite different from a simple, constant-rate turn on the spot.

Animations can be produced using motion-capture techniques. In these techniques, the movement of an actor performing an activity is recorded at a motion-capture studio and used to model movement of a character in a computer game. The movement of individual body-parts of the actor over the duration of an actor's movement is detected and used to create a sequence of motion-capture frames defining a movement. In order to combine different animations together in sequence in a game, often referred to as splicing, it is desirable that each animation begins and ends in one of a number of pre-determined body positions known as ‘poses.’ This helps give continuity between animations by making the transition between them smoother and more natural-looking The motion-capture studio may be provided with data defining each pose, and which pose each animation should start with and end with. The motion-capture studio may then process the motion-captured data and provide a data file which defines the animation as a sequence of key-frames, where the first and last key-frames match the desired poses.

An actor and his movement may be modelled as an entity with a hierarchy of parts, referred to herein as “bones”. The top of this hierarchy may be a bone representing the actor's hip. In raw motion-captured data, all other movement is typically defined relative to a hip bone body-part.

An unknown for any motion-captured entity position is the true forward direction for the entity. The motion-captured data defines the motion of the hip bone, including its horizontal forward direction. During a looped walk or run animation, the hip twists from side to side as the entity moves one leg forward after the other. This means that the hip forward direction swings from side to side during the animation.

An entity animated will be capable of being viewed on a display from a third-person perspective, with the viewpoint linked to the entity's position. This means that if the hip forward direction is used directly as the entity's forward direction, then as the entity runs forwards, the viewpoint will swing from side-to-side in line with the hip motion. Such motion may be disconcerting to a user who is controlling the movement of the entity in the virtual environment.

U.S. Pat. No. 6,972,765 B1 describes a method for producing three-dimensional (3D) animated graphics images comprising objects on a graphics interface. The graphics images are designed to be interactively animated, in real time, by the users for whom they are designed. The method includes selecting objects and displaying them on a graphics interface, assigning movements to the objects which have the property of interactively reacting, in real time, to external prompting, and assembling visual elements on the graphics interface which symbolise the objects and the movements assigned to them.

Japanese patent application no. JP 2007-038010 describes an animation system for achieving animation of characters in a two-dimensional game. A game-character is divided into different areas, to which different animation techniques are applied. In one area, a bone animation technique is used, where logic to control the motion of an object is used. In another area, a cell animation technique is used. The areas using different animation techniques are then combined in order to animate the character.

Korean patent application no. KR 2004 0087787 describes a system for modifying the form of a character in a three-dimensional online game. Animation of the character is achieved by animation of the individual bones of the character. The bone animation model for one character can be extended to other character models by exporting shapes based on a bone in one character to other characters. Inverse kinematics can be applied to increase the reality of the character animation in response to manipulation of the character by a player.

It would be desirable provide techniques used in gaming systems which improve the look and feel of user-controlled entity movements and animate entities more realistically in virtual environments.

### SUMMARY OF THE INVENTION

In accordance with a first aspect of the present invention, there is provided a server-based method for controlling animation on a client of a user-controlled entity in a virtual environment, said user-control being client-based, said method comprising:

storing, on a server, first entity tracking data associated with tracking of a first entity in said virtual environment;

receiving, on said server from a first client, entity-control input data associated with user-control of said first entity in said virtual environment;

on the basis of said input data received from said first client, selecting, on said server, a first animation to be animated on said first client, said first animation to be animated on said first client being selected from a first plurality of animations;

transmitting, from said server to said first client, first data identifying said first selected animation of said first entity in said virtual environment;

retrieving one or more entity variation characteristics associated with said first selected animation to be animated on said first client; and

on the basis of said retrieved entity variation characteristics associated with said first selected animation to be animated on said first client, updating said stored first entity tracking data.

Entity tracking data is stored on the server in order to track movement of the entity in the virtual environment. A user may input a desired action for their entity via their client, which can then be transmitted by the client to the server. The server uses the received data to select an appropriate animation for the entity. The server then transmits data identifying the selected animation to the client, thus controlling animation of the entity on the client.

Entity variation characteristics associated with a selected animation may be retrieved by the server, for example from memory storage on the server. Entity variation characteristics may relate to certain characteristics which vary over the course of animations, such as the location and orientation of the entity and timing of the animations. Use of entity variation characteristics provides the server with information relating to how the entity varies over the course of an animation, for example where the entity may be and/or which way it may be facing during an animation, relative to the start of the animation, in particular at the end of an animation. The server may update the entity tracking data it stores in view of the entity variation characteristics of the selected animation.

The server is thus able to keep track of the entity in the virtual environment, and also has knowledge of a plurality of entity animations which may be used to animate the entity on the client. By using animation data to simulate movement of the entity, along with keeping an accurate representation of the movement of the entity in the virtual environment, the server may control the entity accurately and therefore animation of the entity may be more realistic.

A network through which the server and client may communicate need not be overloaded with an unnecessarily large volume of animation data. Animation data itself need not be transmitted between the server and client, only data associated with the identified animation need be transmitted, which can subsequently be used by a client to identify the relevant animation.

Preferably, the method comprises further selecting said first animation to be animated on said first client on the basis of said stored first entity tracking data. Hence, the server may also use stored tracking data to select an appropriate animation for the entity. The animation selection can thus be carried out with knowledge of the movement of the entity in the virtual environment which can further increase animation quality.

Preferably, the first stored entity tracking data comprises location data associated with tracking of a location of said first entity during a series of animations. For example, the location data may comprise a start location for an entity in an animation.

Preferably, the first stored entity tracking data comprises orientation data associated with tracking of an orientation of said first entity in a series of animations. For example, the orientation data may comprise a start orientation for an entity in an animation.

Preferably, the first stored entity tracking data comprises timing data associated with tracking of a timing of said first entity during a series of animations. For example, the timing data may comprise a start time for an entity in an animation.

Hence, the location, orientation and timing of the entity in the virtual environment may be tracked on the server on the basis of the selected animation, thus helping to provide a more accurate representation of movement of the entity in the virtual environment when the entity is animated on the client.

Preferably, the method comprises:

selecting, on said server, an additional animation to be animated on said first client from said first plurality of animations;

transmitting, from said server to said first client, additional data identifying said additional animation to be animated on said first client;

retrieving one or more additional entity variation characteristics associated with said additional selected animation; and

on the basis of the retrieved additional animation, updating said stored first entity tracking data.

Preferably, the first and said additional selected animations are selected for animation in sequence, with consequential tracking being performed on the server for the sequence of animations.

Preferably, the plurality of animations is derived from motion-captured data. Hence, data associated with movements of an actor in a motion-capture studio may be employed as source data for the movement animation.

Preferably, the method further comprises:

storing, on said server, second entity tracking data associated with tracking of a second entity in said virtual environment;

receiving, on said server from a second client, entity-control input data associated with user-control of said second entity in said virtual environment, said second client being remote from said first client;

on the basis of said input data received from said second client, selecting, on said server, a first animation to be animated on said second client, said first selected animation to be animated on said second client being selected from a second plurality of animations;

transmitting, from said server to said second client, data identifying said first selected animation to be animated on said second client in said virtual environment;

retrieving one or more entity variation characteristics associated with said first selected animation to be animated on said second client; and

on the basis of said retrieved entity variation characteristics associated with said first selected animation to be animated on said second client, updating said stored second entity tracking data.

Hence, the invention may be employed to provide multi-user functionality over a network. Each client may be remote from other clients and each may be operated by a user used to control one or more entities in the virtual environment. One or more servers may communicate with the clients in order to control animation of their respective entities, whilst the entities are tracked on the one or more servers on the basis of the selected animations.

Preferably, the method comprises further selecting said first animation to be animated on said second client on the basis of said stored second entity tracking data. Hence, the server may use stored tracking data to select appropriate animations for more than one entity. The animation selections can thus be carried out with knowledge of the movement of multiple entities in the virtual environment.

Preferably, the first plurality and second plurality comprise one or more entity animations in common. Hence, each client may have the same or a similar set of animations by which their associated entity may be animated.

Preferably, the selection of said animation in said first plurality is dependent on said selection of said animation in said second plurality if said first entity and said second entity are to interact in said virtual environment.

Hence, depending on the user-control of each entity, the entities associated with each client may be animated so that they interact with each other in the virtual environment. The server may thus select animations for the respective entities accordingly.

In accordance with a second aspect of the present invention, there is provided a client-based method for movement animation on a client of a user-controlled entity in a virtual environment, said user-control being client-based, said method comprising:

storing animation data on a first client, said stored animation data comprising a first plurality of entity animations;

processing, on said first client, first entity tracking data associated with tracking of a first entity in a virtual environment;

transmitting entity-control input data from said first client to a server, said input data being associated with user-control of a first entity in said virtual environment;

receiving first data, on said first client from said server, said received first data comprising first selection data identifying an entity animation in said first plurality; and

animating said first entity in said virtual environment on said first client on the basis of said first received data, said animation data stored on said first client, and said first entity tracking data.

Hence, the present invention allows a user-controlled entity to be animated in a virtual environment according to animation data stored on a client. A user may input a desired movement for their entity via their client, which can then be transmitted to a server. The client then receives data from the server informing it which entity movement animation has been identified by the server. The client may process entity tracking data in order to track the entity during the identified animation.

The server is thus able to keep track of the entity in the virtual environment, and also has knowledge of a plurality of entity animations which may be used to animate the entity on the client. By using animation data to simulate movement of the entity, animation of the entity in the virtual environment may be simulated more realistically.

Preferably, the method comprises receiving, on said first client from said server, said first entity tracking data. Hence, the client may be provided with entity tracking data by the server.

Preferably, the method comprises storing said first entity tracking data on said client, wherein said processing of said entity tracking data comprises retrieving said entity tracking data from said store on said client. Hence, the client may store entity tracking data itself. The client may keep its own version of the entity tracking data instead of receiving entity tracking data from the server. Alternatively, or in addition, the client may receive entity tracking data from the server and use this directly to animate the entity, or the client may use entity tracking data received from the server to update its own stored entity tracking data.

Preferably the method comprises processing, on said client, entity variation characteristics associated with said identified entity animation;

on the basis of said processed entity variation characteristics, updating said first entity tracking data; and

further animating said first entity in said virtual environment on said first client on the basis of said updated first entity tracking data.

Hence, the client may process entity variation characteristics associated with an identified animation. Use of entity variation characteristics provides the client with information relating to how the entity varies over the course of an animation.

Preferably, the method comprises receiving said entity variation characteristics on said client from said server. Hence, the client may be provided with entity variation characteristics by the server.

Preferably, the method comprises storing said entity variation characteristics on said client, wherein said processing of said entity variation characteristics comprises retrieving said entity variation characteristics from said store on said client. Hence, the client may store entity variation characteristics itself. The client may keep its own version of the entity variation characteristics or may be provided with entity variation characteristics by the server, in which case the client may update its stored entity variation characteristics.

In accordance with a third aspect of the present invention, there is provided a method for movement animation of a user-controlled entity in a virtual environment, said method comprising:

storing animation data derived from motion-captured data, said stored animation data comprising an entity movement animation, said entity movement animation including body-part movement data for individual body-parts of said entity;

receiving entity-control input data, said input data being associated with user-controlled movement of said entity in said virtual environment; and

animating said entity in said virtual environment according to said stored animation data in a third person perspective view, wherein the location and orientation of said third person perspective view is defined by at least some of said body-part movement data.

Hence, a user may view the movements of their entity in the virtual environment from a third person perspective. This viewing angle or camera angle that the user sees their entity from may track the entity according to its body-part movement data.

The invention may be used to provide a third person perspective view during movement animation of an entity in a virtual environment. Animation data may be derived from the motions of an actor recorded in a motion-capture studio. Body-part movement data may be derived from the motion-capture data and used at least in part to define the third person perspective view giving a more stable and realistic view during animation of the entity in the virtual environment.

Preferably, the motion-captured data includes a plurality of motion-capture frames, and the location and orientation of the third person perspective view is defined by body-part movement data for a body-part which is derived from said motion-captured data by smoothing between motion-capture frames.

Hence, smoothing between frames of the motion-capture data may be employed to produce a third person perspective view during animation. This may help to avoid any oscillation, wobble, jitter or suchlike associated with the motion-capture data being undesirably manifested in the third person viewing perspective. Such undesirable effects could for example be due to one or more parts of the actor moving from side to side whilst his motion is being recorded, for example due to oscillation of the actor's hip bone during recordal of a running action.

Preferably, the entity movement animation comprises a plurality of key-frames, and wherein said third person perspective view location for a key-frame is derived from a location of said body-part in one or more of said motion-capture frames, and said third person perspective view orientation for a key-frame is derived from an orientation of said body-part in one or more of said motion-capture frames.

Preferably, the one or more motion-capture frames comprise the first and/or last motion-capture frames in said plurality of motion-capture frames.

Hence, the location and/or orientation of the third person perspective view for a key-frame in the animation may be derived from the location and/or orientation of a body-part in one or more motion-capture frames, for example the first and/or last motion-capture frames associated with a recorded action.

Preferably, the third person perspective view orientation for a key-frame comprises defining one or more directions associated with the orientation of said body-part in one or more motion-capture frames.

Preferably, deriving the third person perspective view orientation for a key-frame comprises determining a relationship between said one or more body-part orientation directions and a reference in said virtual environment.

Preferably, the reference comprises a reference direction in said virtual environment.

Preferably, the relationship comprises one or more angles between said body-part orientation directions and said reference direction.

Hence, the orientation of a body-part in one or more motion-capture frames may be used to calculate an orientation of the entity in one or more key-frames in an animation. The orientation of a body-part may be compared with the orientation of a reference in the virtual environment. This may involve determining a relationship, such as an angle, between a direction of an axis formed by a body-part and a reference direction in the virtual environment.

This process may be considered as a form of normalisation of the body-part movement data, whereby the orientation of the body-part is normalised in relation to the orientation of the reference in the virtual environment. The true direction that an actor is facing in a motion-captured movement will typically be unknown. The normalisation process of the invention allows an indication of which direction the entity is facing in the virtual environment during an animation to be calculated. The derived direction of the entity can then be used to provide a stable and realistic third person perspective view during animation of the entity.

Knowledge of the entity orientation may be employed by the server when it is calculating in which direction an entity will or should be facing at the start and/or finish of an animation, which knowledge may not be implicit from motion-captured data. This may be especially useful when multiple animations are to be sequenced together.

Preferably the one or more angles are used to determine said third person perspective view orientation for a key-frame. Thus, one or more angles calculated between one or more body-parts and a virtual environment reference direction may be used to determine the third person perspective view in an animation.

Preferably, the third person perspective view orientation for a key-frame in said animation is calculated using the third person perspective view orientation of two or more other key-frames in said animation. Hence, the third person perspective view orientation need not be directly calculated from the orientation of a body-part for each key-frame individually. Instead, the third person perspective view orientation may for example be calculated directly from body-part orientation data for only two key-frames and the third person perspective view orientation for these two key-frames used to calculate the third person perspective view orientation in other key-frames of the animation.

Preferably, the two or more other key-frames comprise the first and last key-frames in said animation. The third person perspective view orientation of the first and last key-frames may for example be used to calculate the third person perspective view orientation of all other key-frames in an animation.

If the entity orientation is calculated from body-part orientation data from the first and last key-frames of an animation, then this information may be used to calculate the entity orientation of one or more, or all of the intermediate key-frames. This may involve smoothing the orientation of the entity from the first and last key-frames over the intermediate frames. The smoothing may be carried out by averaging the orientation of the entity from the first to last key-frame over the intermediate key-frames, for example using linear interpolation.

Preferably, deriving said third person perspective view location for a key-frame comprises displacing the location of said body-part in one or more motion-capture frames.

This process may be considered as a form of normalisation of the body-part movement data, whereby the location of the body-part is normalised in relation to a location in the virtual environment. The true location that an actor is situated at in a motion-captured movement will typically be unknown. The normalisation process of the invention allows an indication of the location of the entity in the virtual environment during an animation to be calculated. The derived location of the entity can then be used to provide a stable and realistic third person perspective view during animation of the entity.

The displacement of the normalisation process may involve subtracting a fixed amount in the vertical height plane of the entity in the virtual environment. To avoid a negative height for the third person perspective view location, the displacement may be limited by a reference height in said virtual environment, for example the height of the ground in the virtual environment.

Preferably, the entity is an osteoid character. Hence, the entity may have a skeleton of bones, each entity bone having one or more sensors attached to body-parts which represent movements of corresponding bones of an actor in the motion-capture studio. The individual movements of each of the bones may be recorded and used to animate the entity accordingly.

Preferably, the body-parts comprise two body-parts corresponding to the hip-bone of said entity. Hence, movement of the hip-bone of an actor may be used to derive a third person perspective view during animation of an entity in a virtual environment. Motion-captured data will typically include data associated with the movement of the hip-bone of an actor, which may be used to calculate the location and orientation of the entity in an animation.

In accordance with a fourth aspect of the present invention, there is provided a method for movement animation of a user-controlled entity in a virtual environment, said method comprising:

storing animation data, said stored animation data including a plurality of entity movement animations, each of said entity movement animations having associated entity variation characteristics;

receiving entity-control input data, said input data being associated with user-controlled movement of said entity in said virtual environment;

on the basis of said input data, selecting an entity movement animation from said plurality and modifying said selected animation such that the entity variation characteristics associated with said selected animation are modified; and

animating said entity in said virtual environment according to said modified animation.

When entity-control input data is received, a suitable entity movement animation may be selected from the stored animation data. However, the selected animation may be modified prior to being used to animate an entity in the virtual environment in order that the entity is animated more realistically. An entity movement animation may have associated entity variation characteristics relating to how the entity varies in an animation. Hence, instead of animating the entity directly according to stored animation data corresponding to a selected animation, the selected animation may first be modified in order to vary its associated entity variation characteristics.

This may be used to adjust the location and orientation of the entity to make the look and feel of the animation more realistic, for example so that the animation concords with the animation of another entity or object to be animated in the virtual environment.

It may be impractical to provide animation data for every possible variation of an entity movement, in terms of horizontal and vertical displacement, direction, timing, etc. This may especially be the case if the animation data was derived from motion-captured data as it may be difficult to have an actor act out many different variations of a certain movement type with any great degree of accuracy or preciseness.

Hence, by use of the present invention, animation of an entity need not be restricted to exactly the animations which have been provided and a selected animation may be modified to fit more closely with the desired movement of the entity. This may occur for example if an entity should preferably arrive at a particular location, angle and time in an animation, in order to interact with another entity or object in the virtual environment.

Preferably, the entity variation characteristics comprise the location and/or orientation of said entity in said entity movement animations and said modification comprises modifying the location and/or orientation of said entity in said selected animation. Hence, when an animation is selected, its entity variation characteristics may be checked to see if they indicate that the selected animation is close enough to the desired movement of the entity and is thus suitable for direct animation in the virtual environment. If it is recognised that the animation is not acceptable for direct animation, for example the location and/or orientation of the entity could be improved, then the animation may be modified in order to change the entity variation characteristics of the animation before being used to animate the entity in the virtual environment.

Preferably, the entity movement animations comprise a plurality of key-frames, and

wherein said entity variation characteristics comprise the variation in the location and/or orientation of said entity between first and second key-frames in said entity movement animations. Hence, the variation of entity variation characteristics such as the location and/or orientation of an entity between certain points in the animation may be employed as a measure of how closely an animation follows a desired entity movement.

Preferably, the entity movement animations comprise body-part movement data for individual body-parts of said entity, and

wherein entity variation characteristics associated with said entity movement animations comprise the location and/or orientation of one or more of said body-parts of said entity.

If the entity variation characteristics of an animation indicate that the location and/or orientation of one or more body-parts in an animation could be improved so that movement of the body-parts more closely fit a desired entity action, then the location and/or orientation of the one or more body-parts in an animation may be modified before the entity is animated in the virtual environment.

Preferably, a modification of said selected animation comprises modifying the location and/or orientation of one or more body-parts of said entity in said selected animation. Hence, the look and feel of an animation may be improved by modifying the location and/or orientation of one or more body-parts of the entity.

Preferably, the entity variation characteristics associated with entity movement animations comprise the variation in the location and/or orientation of said one or more body-parts between said first and said second key-frames. Hence, the variation of entity variation characteristics such as the location and/or orientation of one or more body-parts of an entity between certain points in the animation may be employed as a measure of the how closely an animation follows a desired entity movement.

Preferably, the first and/or said second key-frames comprise the first and/or last key-frames in said animations. Hence, the start and finish location and/or orientation of the entity or one or more body-parts of the entity in an animation may be adjusted in order to improve how the animation splices together with previous and subsequent animations for that entity, or with animations associated with other entities and/or objects in the virtual environment.

Preferably, the stored animation data comprises object animation data, said object animation data being associated with the movement of one or more objects within said entity movement animations, and

wherein said modification comprises modifying the location and/or orientation of said one or more body-parts in relation to said one or more objects.

Hence, a modification may involve modifying the location or orientation of an entity or one or more body-parts of an entity with respect to an object such as a ball, or vice versa, so that an entity may interact with the ball in a more realistic manner, for example in order to kick it or head it, etc.

Preferably, a modification comprises identifying a subset of key-frames of an entity movement animation to which said modification should be applied. The modification may be more realistically applied to a subset of key-frames in an animation rather than the whole animation. This may be useful for example where the majority of a turn or other such movement of an entity occurs over only a few key-frames in an animation, in which case the modification may best be applied over those few key-frames only. A subset of an animation may be identified prior to storage of animation data on the client and/or server, or may be identified by the server or client using image processing techniques.

Preferably, a subset of key-frames is identified by key-frames in which a given body-part of said entity is at a given location and/or in a given orientation. Hence, a subset may be identified for example by key-frames in which the feet of an entity are on the ground or orientated in a certain direction or suchlike.

Preferably, a subset of key-frames is identified by key-frames in which a given object is at a given location and/or in a given orientation. Hence, a subset may for example be identified as key-frames in which an object such as a ball is on the ground or at a certain height compared to the height of an entity or suchlike.

Preferably, a given body-part comprises a foot and/or the head of said entity, said given object comprises a ball and said modification comprises modifying the location and/or orientation of said foot or said head in relation to the location and/or orientation of said ball. Hence, the modification may be used to realistically animate an entity that is being controlled by a user in a sports game, such as a player in a football match.

Preferably, a modification comprises using inverse leg kinematics to modify the location and/or orientation of one or more leg body-parts of said entity in said subset of key-frames. Hence, if a modification for example involves modifying the points at which the feet of an entity are on the ground, the location and orientation of the legs of the entity may be modified to give the legs a more natural look in the modified animation. The thighs, knees, calves, ankles or feet of the entity, etc. may be involved in such inverse leg kinematics processes.

Preferably, a modification comprises modifying the timing of one or more key-frames in said entity movement animation. Hence, a modification may for example involve speeding up or slowing down an animation such that an entity may arrive at or leave an object or other entity in a more natural manner. This may for example involve kicking a ball or tackling another entity or suchlike.

According to a fifth aspect of the present invention, there is provided a computer-implemented multi-player sports game comprising animation performed over a data communications network according to the previous aspects of the present invention, wherein each player controls one or more entities in said game over said network via a client.

Hence, the invention may be used to animate players in a Massively Multi-player On-Line (MMO) game played over the internet with multiple users controlling their entities via their clients and a server controlling movement animation of each of the entities.

In accordance with a sixth aspect of the present invention, there is provided apparatus adapted to perform the method of any one or more of the first, second, third and fourth aspects of the present invention.

In accordance with a seventh aspect of the present invention, there is provided a computer program product comprising a computer-readable medium having computer readable instructions recorded thereon, the computer readable instructions being operative, when performed by a computerised device, to cause the computerised device to perform the method of any one or more of the first, second, third and fourth aspects of the present invention.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a system diagram for a networked gaming environment according to an embodiment of the present invention.

FIG. 2 is a flow diagram showing steps involved in preparing data files for a game according to an embodiment of the present invention.

FIG. 3 shows a motion-capture data editing system according to an embodiment of the present invention.

FIG. 4 is a flow diagram showing the steps involved in editing motion-capture data according to an embodiment of the present invention.

FIGS. 5a and 5b show calculation of entity orientation data for key-frames according to an embodiment of the present invention.

FIG. 6 shows server functional elements according to an embodiment of the present invention.

FIG. 7 shows client functional elements according to an embodiment of the present invention.

FIG. 8 shows server-based animation data storage according to an embodiment of the present invention.

FIG. 9 shows client-based animation data storage according to an embodiment of the present invention.

FIG. 10 is flow diagram showing steps carried out on a client and server during animation of an entity according to an embodiment of the present invention.

FIGS. 11a and 11b show modification of key-frames of an animation according to an embodiment of the present invention.

### DETAILED DESCRIPTION OF THE INVENTION

### Game System

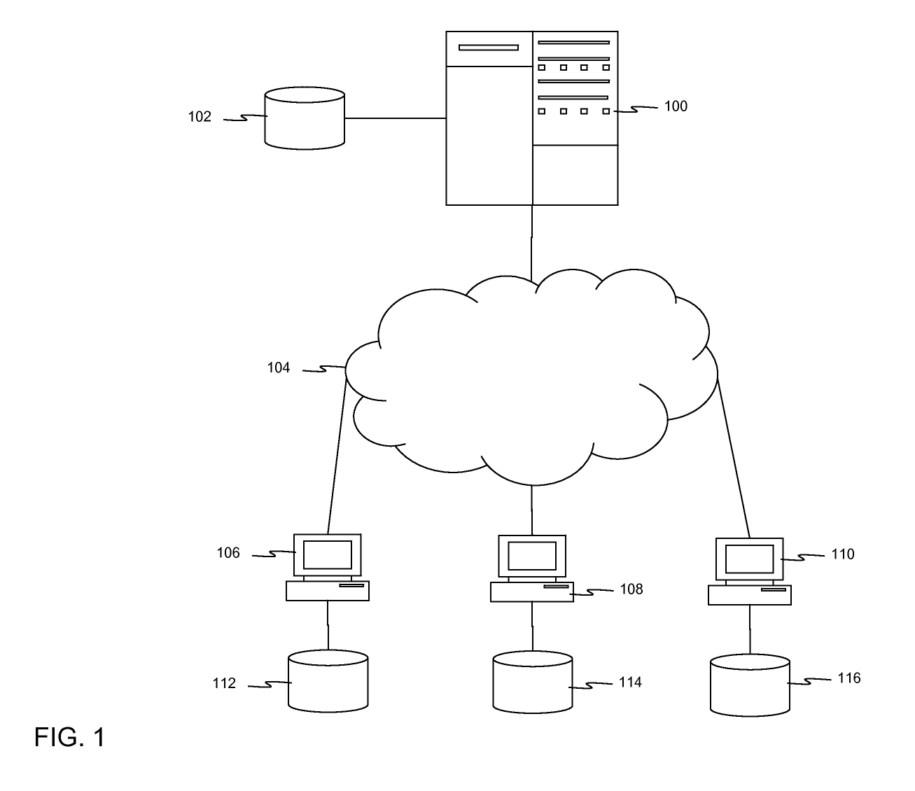

FIG. 1 shows a system diagram for a networked gaming environment according to an embodiment of the present invention. Server 100 is connected via a data communications network 104 to a number of clients 106, 108, 110. Clients 106, 108, 110 may include personal computers (PCs), personal digital organisers (PDAs), laptops, or any other such computing device capable of providing data processing and gaming functionality. Server 100 and clients 106, 108, 110 each have access to data storage facilities 102, 112, 114, 116 respectively, on which data relating to the gaming environment is stored. The data storage facilities may be internal or external to the server or clients.

Server 100 is responsible for controlling a multi-player game over network 104. The game includes a virtual world or other such virtual environment in which entities such as characters or avatars or suchlike are controlled by users of clients 106, 108, 110. Users of clients 106, 108, 110 input entity-control data via a keyboard, mouse, joystick or other such input device to make their entities move around in the virtual environment.

Server 100 is responsible for simulating a virtual environment for the game in which the entities participate and for processing input data from each of the clients in order to determine how the entities should move and interact. Such simulations may include a multi-player sports game such as a football or basketball match, or an adventure game.

### Animation Editing System

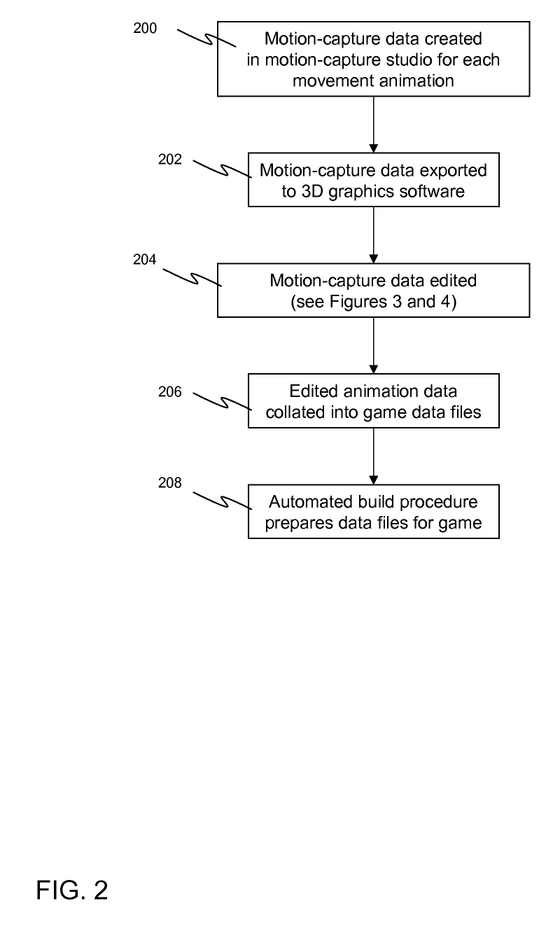

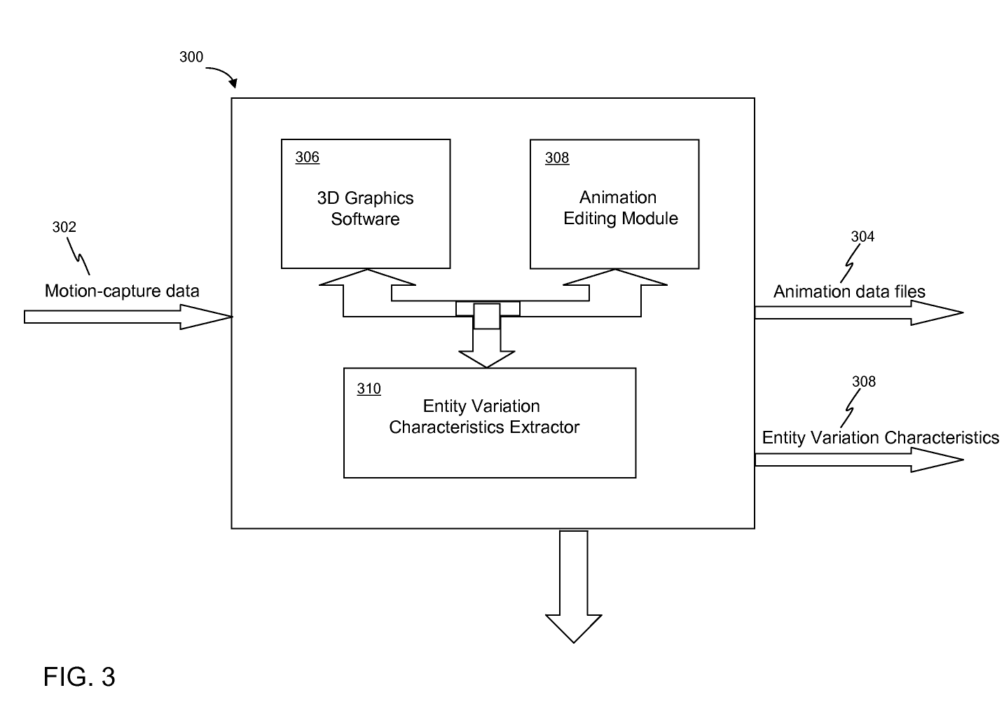

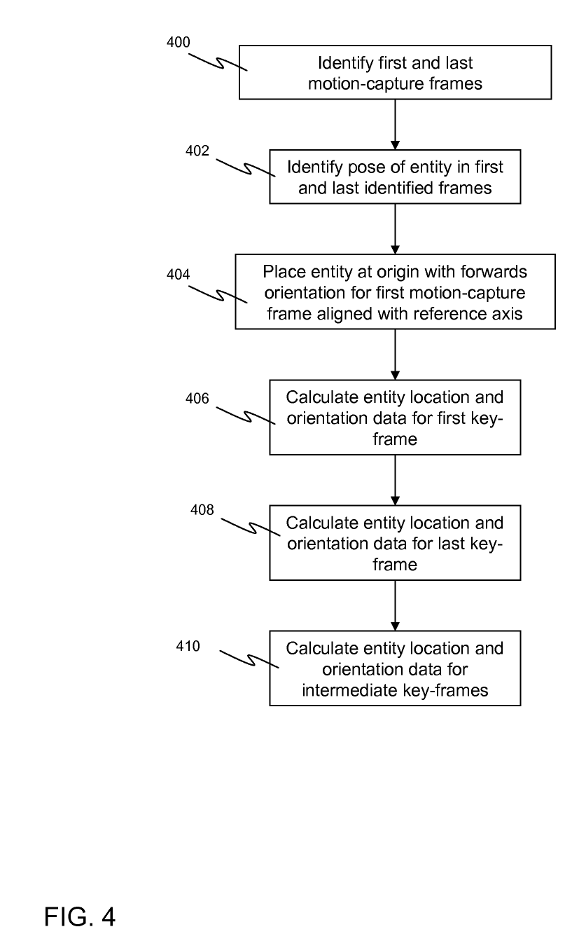

FIG. 2 is a flow diagram showing steps involved in preparing data files for movement animation according to an embodiment of the present invention. Step 200 involves creation of motion-capture data in a motion-capture studio where an actor's movements are recorded to define movement animations that an entity may carry out in the game. The motion-capture data is exported in step 202 to 3D graphics software which allows the data to be viewed on a computer screen or other such graphics display device. Motion-capture data received from a motion-capture studio may be viewed in a computer software application with 3D graphics functionality capable of processing motion-capture data files, such as 3ds Max™ (also known as 3D Studio Max™), developed by Autodesk, Inc. Step 204 involves editing the motion-capture data to produce animation data according to the invention. The editing of motion-capture data is described in more detail with reference to FIGS. 3 and 4 below. The edited data is then collated in step 206 with other game data files required for playing the game.

An automated build procedure is then used in step 208 to prepare data files for the client and the server which are required to animate the entity in the virtual environment. The entity is animated during a game controlled by a server played over a data communications network and may involve multiple players each controlling one or more entities via client devices. Part of the build procedure generates a single data file defining animation for all supported entity movements. In the example of a sports game, this file may also contain data associated with movement of a ball, puck, etc. in one or more of the animations. The build procedure produces output data which may be stored on and used by both the server and each client.

FIG. 3 shows a motion-capture data editing system according to an embodiment of the present invention. Motion-capture data 302 is input to the editing system 300 which edits the motion-capture data to produce animation data files 304 as output. The editing system 300 includes 3D graphics software 306 which is capable of processing motion-capture data, for example 3D Studio Max™ described above. An animation editing module 308, capable of editing the motion-capture data, interfaces with the 3D graphics editor. The animation editing module may be in the form of a plugin to 3D graphics software 306. An entity variation characteristics extractor 310 interfaces with both the 3D graphics software 306 and the animation editing module 308 in order to extract entity variation characteristics 308 from the motion-capture data. Entity variation characteristics are explained in more detail below.

### Movement Smoothing

FIG. 4 is a flow diagram showing the steps involved in editing motion-capture data according to an embodiment of the present invention. The editing process converts motion-capture data into animation data files which can be used for movement animation according to embodiments of the present invention. The animation data files may include a plurality of key-frames for each entity animation. The data required for each key-frame in an animation need not be derived directly from the motion-capture data. Instead, data for one or more key-frames in an animation may be calculated, for example the first and last key-frames, and data required for intermediate key-frames derived from the first and last key-frames by a smoothing process as described below.

Editing for an animation begins by identification of one or more motion-capture frames in the motion-capture data. In this example, the first and last motion-capture frames are identified in step 400, although any other motion-capture frames or a single motion-capture frame may be identified. The pose of the entity in the first and last motion-capture frames, i.e. the entity's location and orientation, are identified in step 402. The entity is placed in a 3D environment generated by a 3D graphics software application (such as 3D Studio Max™ described above) in step 404. The entity may for example be placed at a notional origin of the virtual environment as defined by the 3D graphics software. The orientation of the entity may be aligned with the orientation of a notional reference direction in the virtual environment, as defined by the 3D graphics software.

Entity location and entity orientation data for the first key-frame in the animation is calculated in step 406. Entity location and entity orientation data for the last key-frame in the animation is calculated in step 408. Entity location and entity orientation data for one or more intermediate key-frames between the first and last key-frames of the animation is calculated in step 410. Entity location and entity orientation data for intermediate key-frames may be calculated using entity location and entity orientation data from the first and last key-frames.

In embodiments of the present invention, motion-captured data associated with movement of the hip bone is processed to produce data associated with movement of a new smoothed-movement bone located above the hip bone in a hierarchy. The movement of the smoothed-movement bone is used to represent the actor's location and heading over the ground in the virtual environment. The movement of the smoothed-movement bone is then used to represent the movement of the entity, rather than the movement of the hip bone.

When the smoothed-movement bone data has been extracted from the hip-bone data, modified hip bone data will remain. The combined effect of the new smoothed-movement bone data and the modified hip-bone data will be the same as the original unmodified hip bone data in order to preserve the overall look of the animation. If this were not the case, then the entity animation would not look the same due to the changes in the bone hierarchy due to the separation of the smoothed-movement bone.

According to embodiments of the present invention, the location and orientation of the smoothed-movement bone is linked to a third person perspective through which the entity may be viewed by a user controlling the entity. The smoothed-movement bone moves smoothly around in the virtual environment, so will provide a more natural looking third person perspective view without producing any disconcerting movements which other bones such as the hip bone would.

One or more entity movement reference files may be created containing data relating to the movement of the smoothed-movement bone for each animation. This entity movement data may include data defining the location of the entity and the orientation of the entity.

In an embodiment of the present invention, entity location data for the smoothed-movement bone in each key-frame is calculated as being a fixed distance below the hip bone position, for example its height may be set to be a fixed small distance below the lowest position of any bone at that key-frame. The smoothed-movement bone location may be limited to go no lower than the zero height ground position of the virtual environment.

In an embodiment of the present invention, entity orientation data associated with orientation of the smoothed-movement bone in one or more key-frames is calculated. The smoothed-movement bone may be oriented vertically, rotated generally in the forward heading for the entity. The orientation of the smoothed-movement bone for each key-frame is calculated by positioning the entity in a virtual environment generated by 3D graphics software such as 3D Studio Max™. The entity may be placed at a notional origin of the virtual environment such that a notional reference direction, for example the negative y axis in 3D Studio Max™, is deemed to be the forwards direction in the starting pose for that animation, i.e. the forwards direction in the first key-frame of the animation.

The forwards direction for a specific pose can be obtained from a reference file for that pose. Take for example a run animation which starts in a pose named “run_animation_start_pose.” Data from the motion capture studio for the run animation is deemed to start with the actor standing at the world origin and facing forwards. The initial frame of the animation starting in the run_animation_start_pose is then used as a reference. So, whatever angle the hip bone is at in that frame defines the start angle of the hip bone relative to the forwards direction.

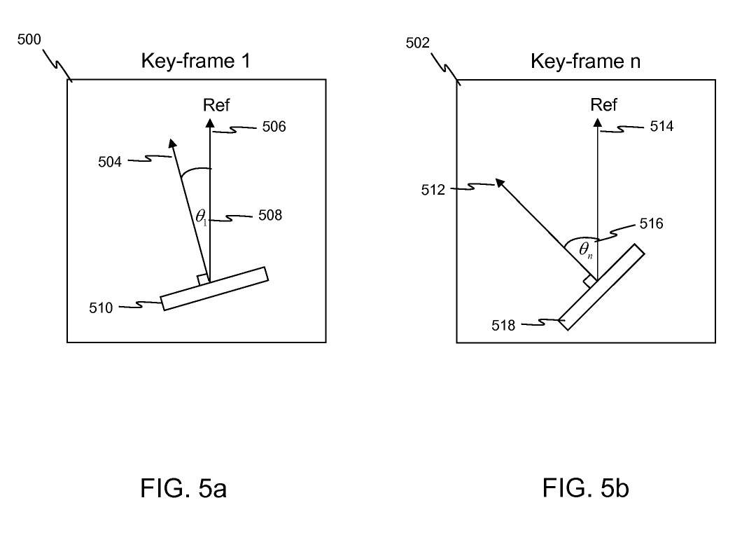

FIGS. 5a and 5b show calculation of entity orientation data for key-frames according to an embodiment of the present invention.

The angle between the reference direction and a direction perpendicular to the hip bone axis is calculated for the first key-frame in the animation and stored in a reference file for the animation. This process is depicted in FIG. 5a according to an embodiment of the present invention.

The first key-frame 500 in an animation shows a reference direction 506 aligned with the deemed forwards direction of the entity in the first key-frame of the animation.

The hip bone of the entity is shown as item 510 and its orientation is defined by direction 504. The angle θ₁ between reference direction 506 and hip bone orientation direction 504 is shown by item 508.

The angle between the reference direction and the hip bone orientation direction is similarly calculated for the last key-frame in the animation and stored in a reference file for the animation. This process is depicted in FIG. 5b according to an embodiment of the present invention.

The last key-frame 502 in the animation includes a reference direction 514 aligned with reference direction 506 of the first key-frame of the animation. The hip bone of the entity is shown as item 518 which can be seen to be orientated differently to the hip bone in the first key-frame of the animation, in this case defining direction 512. The angle θₙ between reference direction 514 and hip bone orientation direction 512 is shown by item 516.

The angles θ₁ and θₙ define offsets of the smoothed-movement bone of the entity for the first and last key-frames of the animation. The respective offsets are applied to the motion-captured hip forward direction to give the smoothed-movement bone forward direction, i.e. orientation of the entity for those key-frames.

In an embodiment of the present invention, the smoothed-movement bone orientation for intermediate key-frames between the first and last key-frames is calculated from the orientation of the smoothed-movement bone in the first and/or last key-frames. This may involve averaging the angle between the smoothed-movement bone orientation in the first and last key-frames. This may involve linear interpolation of the angle between the smoothed-movement bone orientation in the first and last key-frames.

This process provides a smooth rotation of the entity's smoothed-movement bone across the animation (or no rotation for an animation which moves in the forwards direction defined by the reference direction).

According to embodiments of the invention, during animation of an entity, the third person perspective view, or ‘camera angle’ seen by a user on a client is linked to the motion of the smoothed-movement bone. Hence, in the example of a run animation, the camera moves forward smoothly behind the entity, without the unwanted side-to-side swinging motion. The hip bone itself still swings naturally over the animation, so that animation of the entity remains realistic.

Having determined the location and orientation of the smoothed-movement bone in a key-frame, a transformation such as a matrix multiplication may be used to determine the modified hip position. The smoothed-movement bone data for each key-frame and the modified hip bone data for each key-frame is written to an animation data file (see item 304 in FIG. 3) to complete the editing process. A separate animation data file may be created for each entity movement animation or the animations grouped together into a single animation data file.

Other data may be added to the animation data files including data associated with unmodified bones in the bone hierarchy or data associated with movement of objects in the animations, for example defining the movement of a ball, or other such objects where appropriate. Other such objects may include a weapon such as a sword, or other items such as a rock or bag that an entity may pick-up, throw, drop, etc. in an animation, which movements may have been captured accordingly in the motion-capture studio by the actor.

### Game Data

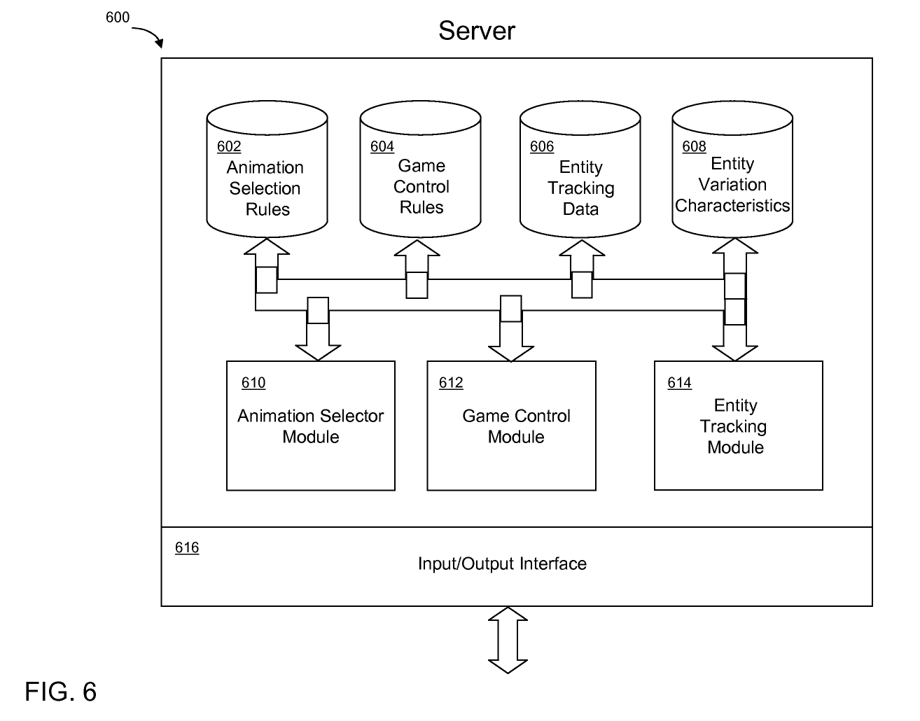

In embodiments of the invention, one or more servers control entity animations on one or more clients. In order to carry out such entity animations, the server and clients are provided with certain functional elements and require access to certain data, which are now described with reference to FIGS. 6 to 9.

FIG. 6 shows server functional elements according to an embodiment of the present invention. Server 600 includes a game control module 612 responsible for controlling games played between a number of clients over a network. Game control module 612 processes user-controlled inputs received from clients via the network and an input/output interface 616. Depending on the desired movement of each entity and a number of rules governing the virtual environment being simulated, game control module 612 decides how each entity should be animated in the virtual environment and transmits appropriate control signals to each entity via input/output interface 616.

The rules by which game control module 612 simulates the virtual environment will depend upon the particular application. In the example of a football match, the rules may include rules relating to the skill, experience or fitness levels of each player, or rules governing which player will win or lose a tackle, reach the ball first, etc. Probability functions may be employed in such rules. Other rules may relate to the size of the pitch, the position of the goals, the length of a game, or the number of players on each team, etc. The game control rules are stored in a game control rules database 604 accessible by game control module 612.

Server 600 includes an animation selector module 610 for selecting appropriate animations for entities on each client. Animation selector module 610 selects animations according to animation selection rules stored in an animation selection rules database 602. Server 600 includes an entity tracking module 614 responsible for tracking the movement, for example the location and orientation, of each entity in the virtual environment. Server 600 includes an entity tracking data database 606 for storing entity tracking data.

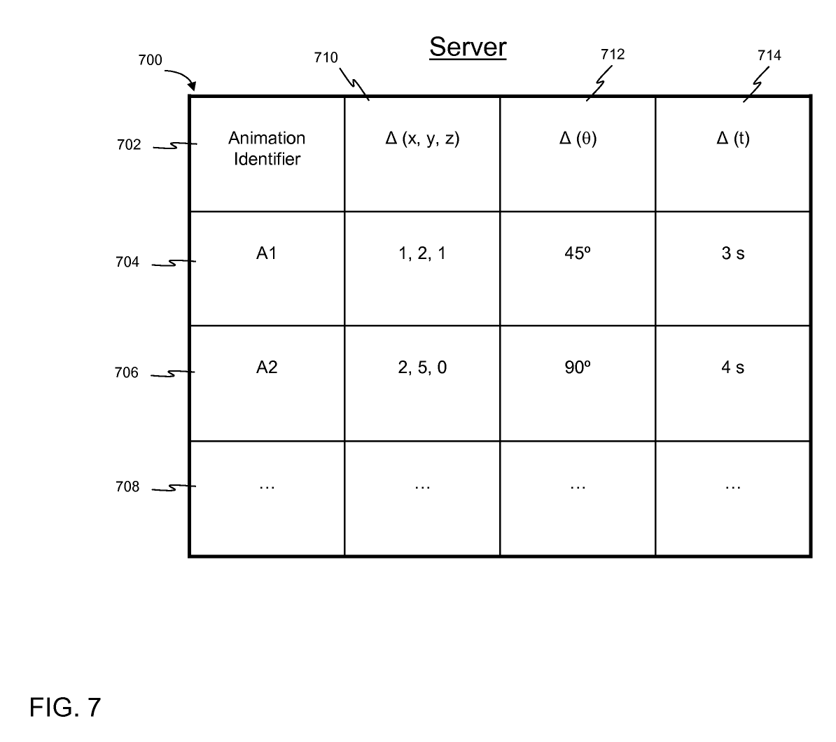

Server 600 also includes an entity variation characteristics database 608 for storing entity variation characteristics, such as the variation in the location and orientation of an entity over the course of an animation; see the description of FIG. 7 below for more details on the contents of entity variation characteristics database 608.

FIG. 7 shows server-based animation data storage according to an embodiment of the present invention. The server-based animation is stored on database 608 shown in FIG. 6, which may be located on the server itself or remotely accessible by the server.

The first column in table 700, headed ‘Animation Identifier’ 702, includes data identifying a number of animations. The second 710, third 712 and fourth 714 columns include entity variation characteristics relating to the animations. Entity variation characteristics relate to certain characteristics which vary over the course of the animations, such as the location, orientation and timing of the entity. Use of entity variation characteristics provides the server with information relating to how the entity varies over the course of an animation, for example where the entity will be and/or which way it will be facing during an animation, in particular at the end of an animation.

The second column 710, headed ‘Δ(x, y, z)’, includes entity variation characteristics for animations relating to the change (denoted by the symbol Δ) in the location of an entity in the x, y and z directions (left-right, forwards-backwards, and up-down respectively) in the virtual environment. The values for x, y, and z given in the table may relate to a notional distance unit or metric in the virtual environment, which provides an appropriate level of distance granularity. The third column 712, headed ‘Δ(θ)’, includes entity variation characteristics for animations relating to the change in the orientation of an entity in the virtual environment. The values for θ given in the table may relate to a notional angular unit or metric in the virtual environment, which provides an appropriate level of angular granularity, in this case degrees. The fourth column 712, headed ‘Δ(t)’, includes entity variation characteristics for animations relating to the change in timing of an entity in the virtual environment. The values for t given in the table may relate to a notional time unit or metric in the virtual environment, which provides an appropriate level of temporal granularity, in this case seconds.

In the exemplary table 700, only two animations with animation identifiers A1 and A2 respectively are included, but many more may be present in an implementation of the invention 708. Row 2 of table 700, denoted by item 704, includes an animation A1 with a location variation of 1 in the x direction, 2 in the y direction and 1 in the z direction, an orientation variation of 45°, and a timing variation of 3 seconds. Row 3 of table 700, denoted by item 706, includes an animation A2 with a location variation of 2 in the x direction, 5 in the y direction and 0 in the z direction, an orientation variation of 90°, and a timing variation of 4 seconds.

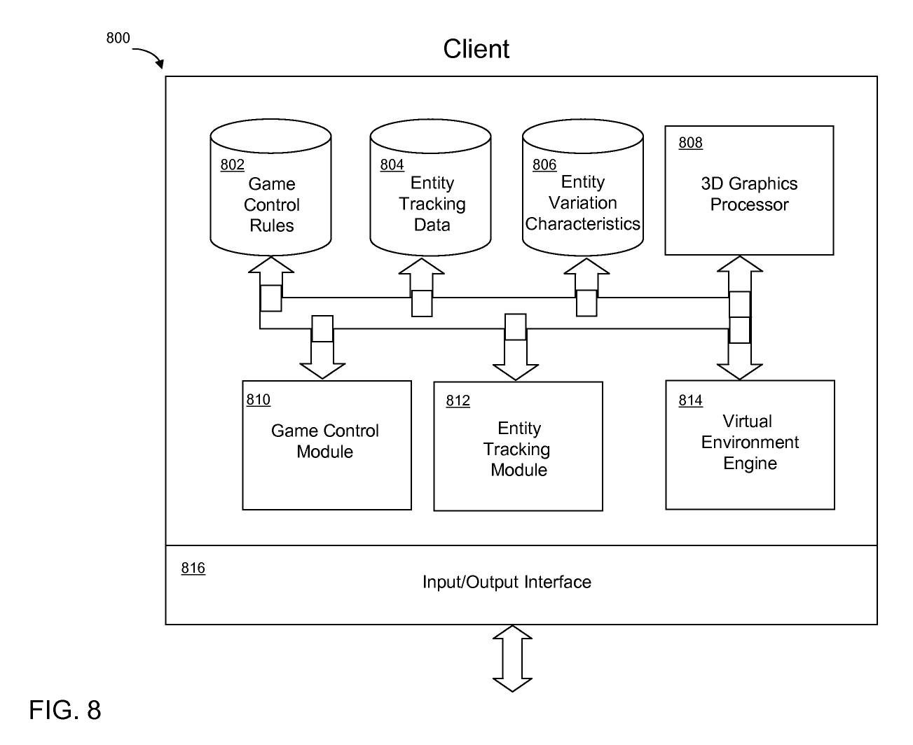

FIG. 8 shows client functional elements according to an embodiment of the present invention. Client 800 includes a game control module 810 responsible for controlling aspects of a game which are not controlled by game control module 612 on the server. The client game control rules are stored in a game control rules database 802 accessible by game control module 810.

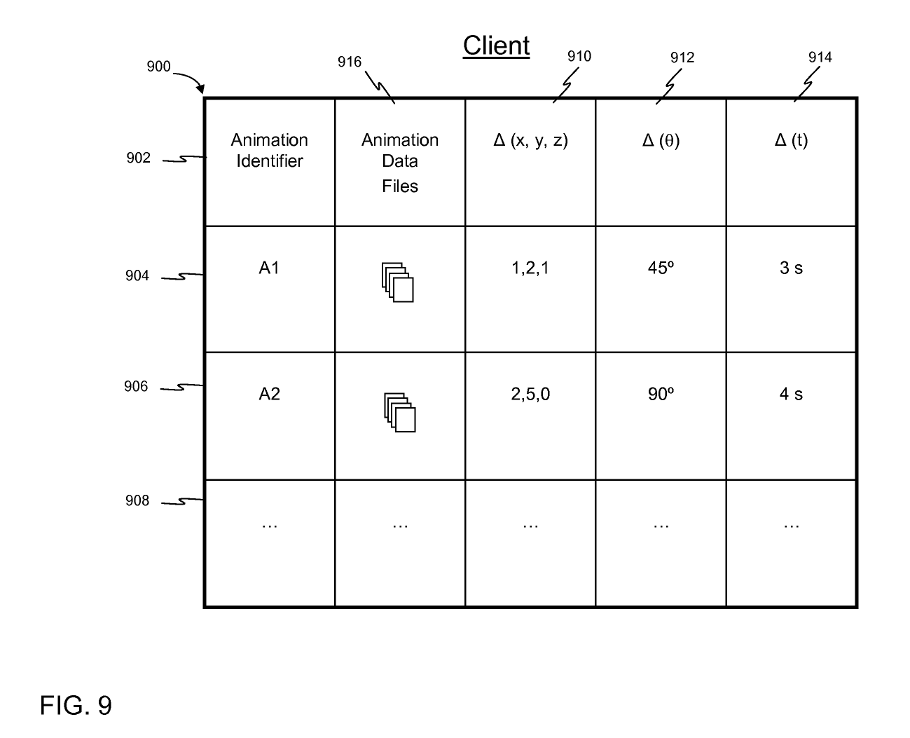

Client 800 also includes an entity variation characteristics database 806 for storing entity variation characteristics; see the description of FIG. 9 below for more details on the contents of entity variation characteristics database 806.

Client 800 includes an entity tracking module 812 responsible for tracking the movement, for example the location and orientation, of one or more entities associated with the client in the virtual environment. Client 800 includes an entity tracking data database 804 for storing entity tracking data.

Client 800 includes a 3D graphics processor 808 for rendering 3D graphics in the virtual environment. Client 800 includes a virtual environment engine 814 for defining the layout, structure and operation of the virtual environment. This may for example involve defining the look and feel of the pitch, such as the touchlines, corner flags, advertising hoardings, goal-posts, etc., and also how each of the entities and objects are animated within that space according to the relevant animation data files.

FIG. 9 shows client-based animation data storage according to an embodiment of the present invention. The data may be stored on database 806 shown in FIG. 8, which may be located on the client itself or remotely accessible by the client.

Table 900 contains much of the same data as is stored on the server as shown in table 700 in FIG. 7, with similar reference numerals being used accordingly. However, table 900 contains an additional column 916, containing animation data files which contain the actual data used for animating the entity in the virtual world. These animation data files need not be stored on the server, although the server may have knowledge of the entity variation characteristics for each animation in order to decide which animations are appropriate for each desired entity movement.

In one embodiment of the present invention, the client stores a copy of the entity variation characteristics stored on the server, in which case the server need only identify an animation to the client and the client can then look-up the relevant animation data file (column 916) and its corresponding entity variation characteristics (910, 912, 914) and animate the entity in the virtual environment accordingly. Here, the client infers the start position (location and orientation) and start time of one animation from the end position and end time implied by a previous animation. These end positions and end times are calculated based on the entity variation characteristics for the selected animation, which are applied to previously stored tracking data for each entity.

In an alternative embodiment of the present invention, start characteristics, in the form of a start position (location and orientation) and start time for an animation are sent from the server to the client in order to instruct virtual environment engine 814 where and when an animation should begin to be simulated in the virtual environment.

In a further embodiment of the present invention, the client need only store the animation data files and corresponding animation identifiers. In such cases, the server informs a client of any entity variation characteristics required to animate the entity in the virtual environment on the client, without the need for such data to be previously stored on the client. The tracking data for each entity can then be calculated as described above in the embodiment in which the entity variation characteristics are stored on the client.

In all these embodiments of the invention, the server sends intermittent animation messages, for example in the form of one or more data packets, which instruct the client at least which animation or a sequence of animations that should be used to animate the entity in the virtual environment, along with start characteristics and/or entity variation characteristics, if appropriate. Such messages can be sent at regular time intervals, or as and when the server deems they are required, or in response to update requests from each of the clients.

In the embodiments above where tracking of entities is performed on the client based on calculations using the entity variation characteristics, messages may also be sent at relatively long intervals (compared to the intervals between animation messages) which contain start characteristics. Such messages can help to reduce the effects of any rounding errors or errors that may occur in network data transmissions, which otherwise may lead to discrepancies between the server and client simulations of the virtual environment.

### Game Play

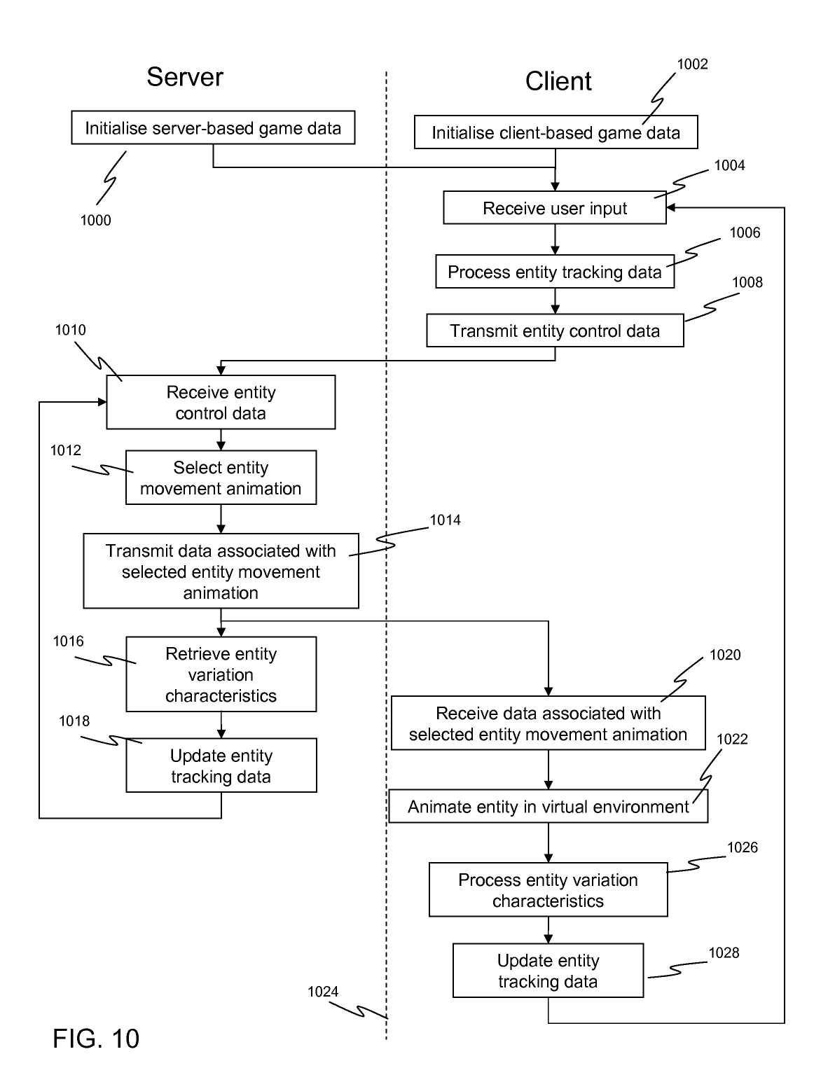

FIG. 10 is a flow diagram showing steps carried out on a client and server during animation of an entity in a virtual environment according to an embodiment of the present invention.

Server-based game data is initialised in step 1000. This may involve loading certain data into random-access memory (RAM) on the server, for example control data for the game and entity tracking data, etc.

Client-based game data is initialised in step 1002. Similarly, this may involve loading appropriate data into random-access memory (RAM) on the client.

When a user wishes to move an entity in a virtual environment, for example when playing a game over a network, the client provides user input via their client device to indicate what the entity should do, as shown in step 1004. Tracking data may be processed by the client in order to track the movement of the entity in the virtual environment in view of the user input, as shown in step 1006.

This information is transmitted in the form of one or more entity control commands to the server in step 1008 over a network (denoted by dotted line 1024). The server receives the entity control data in step 1010, interprets the control data and selects an entity movement animation accordingly, as shown in step 1012. This may involve receiving entity control data from more than one client and selecting entity movement animations accordingly for each client. This may also involve selecting more than one animation for a single client for animation on the client in sequence.

The way in which the server selects which animation to play for each client may be determined by a number of rules associated with the particular virtual environment being simulated. Examples of such rules are described above in relation to game control module 612 in FIG. 6.

From data received from the client, the server has knowledge of the user's desired movement for the entity. The server also has knowledge of the total set of animations available by which the entity may be animated. Using this information, the server selects an animation appropriate to the desired entity movement, or a sequence of animations if appropriate, which may then be spliced together accordingly.

The server may also select an animation for an entity using entity tracking data associated with the location and orientation of the entity, for example the location and/or orientation of the smoothed-movement bone of the entity. Such entity tracking data may be stored on the server, and may also be stored on the client.

The animation data files need not be stored on the server itself, only on each client. Each animation may be identified by a single integer identifier, for example indexed in a table of the entire set of animations, as shown in the first two columns of FIG. 9. The server may only send data identifying an animation and other associated parameters, not the animation data itself. This allows animation of the entity whilst reducing data flow over the network. This can help to avoid latency and congestion issues which would arise if too much data were to flow between the server and clients. The server has an accurate representation of the motion of the entity's smoothed-movement positions, which may be the same as represented on each client. This helps to ensure that all clients have a consistent view of the progress of animations, for example in a networked game, including animations of their own and other entities.

Data associated with the selected movement animation is then transmitted to the client over network 1024 in step 1014. The server thus informs each client which animation or sequence of animations should be performed, for example as defined by the game start time, animation start time, initial entity position (including location and orientation) at the start of the animation, and data identifying the animation(s).

The server retrieves one or more entity variation characteristics related to the selected animation in step 1016 and updates entity tracking data accordingly in step 1018. The server then returns to step 1010 to await receipt of further entity control data.

Data associated with the movement animation selected by the server is received at the client in step 1020 and used to animate the entity in the virtual environment on the client according to corresponding animation data files stored on the client in step 1022.

The client processes entity variation characteristics associated with the selected animation in step 1026 and updates entity tracking data accordingly in step 1028. The client then returns to step 1004 to await receipt of further user input.

In embodiments of the present invention, the processing of step 1026 may involve processing entity variation characteristics received from the server, or may involve processing entity variation characteristics stored on the client. Similarly, the entity tracking updating of step 1028 may involve updating entity tracking data stored on the client or that received from the server.

In the case of the entity being animated in a ball game, the movement of the player may be determined from data associated with the smoothed-movement bone for each animation. If an entity is controlling an object such as a ball, for example dribbling the ball with his feet, for all or part of the animation, the motion of the ball may be determined from appropriate ball animation data. Alternatively if the ball is not under the control of the player, ball motion may be simulated using laws of physics which define the movement of a mass, in this case in a 3D virtual environment, possibly without direct use of animation data.

### Animation Modification

When animating an entity in a virtual environment according to embodiments of the present invention, it may be necessary to modify the animation data before animating the entity on a client. This may be carried out so that movement of the entity is smoothed over an animation in order to sequence with an animation of another entity in the virtual environment, or so that an entity may approach an object such as a ball more realistically, etc.

Such modification may involve the distance travelled by an entity in an animation. This distance modification may involve a forwards or sideways horizontal distance, or a vertical distance for the entity, the latter for example occurring when an entity is to be animated to jump and head a football or suchlike.

Such modification may involve the timing of movement of an entity in an animation, for example speeding up or slowing down an entity so that the animation shows the entity arriving at a position in the virtual environment in such a manner that another entity may be tackled or such like.

Such modification may involve an angle turned by an entity in an animation. It may be impractical to store data associated with turning of an entity for every angle between 0° and 360°, so the client may store animation data just for turning angles at every 45°. If a user-controlled input indicates a turn of say 35°, a suitable animation may be selected by the server, for example one including a turn of 45°, and a turning modification of 10° applied to modify the 45° turn into a 35° turn.

When selecting an entity movement animation (as per step 1012 in FIG. 10), the server may deem that an animation modification is necessary. In such a case, it may transmit data to the client identifying the modification and any required parameters for the animation modification along with data associated with the selected movement animation (as per step 1014 in FIG. 10).

Stored animation data may include a plurality of entity movement animations, each animation having associated entity variation characteristics. Such characteristics may for example define how the location or the orientation of an entity varies over the course of an animation. As another example, such characteristics may define how the location or the orientation of one or more body-parts of an entity vary over the course of an animation.

When a user inputs entity-control data, an appropriate entity movement animation may be selected from a plurality of entity movement animations. However, the selected entity animation may not match the desired entity movement closely enough. In such situations, the selected entity animation may be modified such that the entity variation characteristics fit the desired entity movement more closely.

A turn modification may be applied linearly over the course of the whole animation. However, the majority of the original turn may be condensed into a subset of key-frames in the animation. This may often be the case, particularly where the ball is controlled by an entity, where a complex manoeuvre may be involved.

If a turn modification is applied over the whole animation, the client may see the entity initially turn to the left, then turn back to the right, which is undesirable.

It may therefore be desirable to identify a subset of the animation over which the majority of the turn occurs, and record this timing data with the animation. This may be carried out during editing of motion-captured data (as per step 204 in FIG. 2). This part of the process may be conducted by a human operator, who uses software such as 3ds Max™ to identify the time offsets in the animation at which the turn starts and ends, or may be carried out semi- or fully-automatically using computer-implemented image processing techniques.

Timing data identifying the subset of an animation may then be added when edited animation data is collated together (see step 206 in FIG. 2). During the automated build procedure, the timing data may also be stored in an output file which is available to both server and client.

A turn modification may then be applied over the identified subset of the animation. The turn modification may for example be applied linearly over the identified subset of the animation.

A modification to a turn angle is also likely to modify the final displacement of the smoothed-movement bone over the ground. It may therefore be desirable to also modify the displacement of the smoothed-movement bone when a turn angle modification is applied.

Such a displacement may be represented at any time after the start of the turn modification by assuming that all the rotation modification is applied at the turn start time. This can be described with the following pseudo-code:

Define a clamp function such that clamp(x, a, b) returns the nearest value to x such that a<=x<=b.

Define the position (location and orientation) of the smoothed-movement bone at time t from the start of the animation as T(t). The position can be given as a mathematical representation in the form of a transform, which is typically represented by a 4×4 matrix.

Denote a rotation of angle θ about the vertical axis of the entity as a transform R(θ).

Denote the start and end of the turning period in the animation as time offsets t₀ and t₁ respectively.

Construct the transform representing the modified smoothed-movement bone position Tmod(t) at time t, with the turn modification angle (θ), in the animation as follows:

mod_time=clamp(t, t₀, t₁)

mod_angle=θ*(mod_time−t₀)/(t₁−t₀)

Tmod(t)=T(t₀)*Rz(mod_angle)*inverse(T(t₀))*T(t)

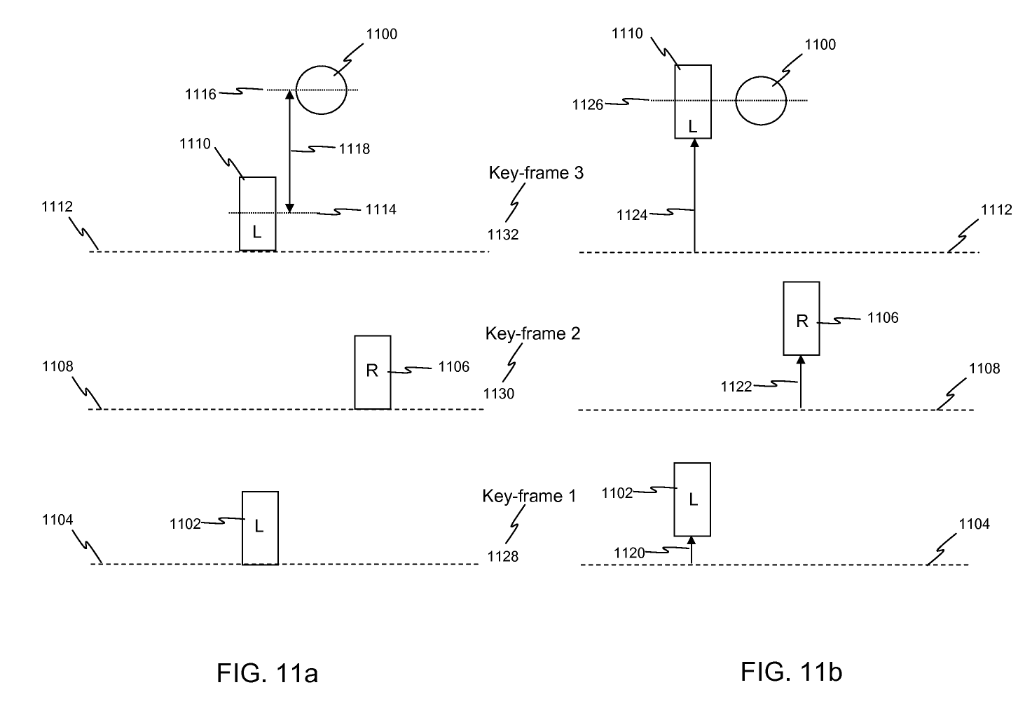

FIGS. 11a and 11b show horizontal modification of an animation according to an embodiment of the present invention.

It may be necessary to modify the horizontal displacement of an entity in an animation. This may occur for example, if an entity is running towards a stationary ball. In order for the entity to control the ball, a number of run animation cycles may need to be played, followed by a ball controlling animation. It is desirable for the ball controlling animation to begin from such a position that the entity's foot contacts the ball at just the right time and place. It is therefore in general necessary to shorten or lengthen the run animations so that the entity arrives at the desired position.

FIG. 11a shows a sequence of three unmodified key-frames of an animation depicting the steps of an entity approaching a ball 1100. The steps are the points at which the feet of the entity are on the ground in the virtual environment. There may be other key-frames in-between the three key-frames shown in this figure where the players feet may be in other positions, but these are not represented in this example.

In the first key-frame 1128, the left foot 1102 of the entity is in line with item 1104. In the second key-frame 1130, the right foot 1106 of the entity is in line with item 1108. In the third key-frame 1132, the left foot 1110 of the entity is in line with item 1112.

When a ball is kicked by a right-footed person, the person will usually adjust their run-up to the ball such that when the ball is kicked by their right foot, the middle of their left foot will be planted to the left of the ball approximately in line with the middle of the ball.

In FIG. 11a, if the server has calculated that the kicking of the ball should begin during key-frame 3 (or in the following key-frame), then the animation may not appear realistic. This is because the middle of the left foot 1110, shown by item 1114, is not aligned with the middle 1116 of the ball 1100. The middle 1116 of the ball 1100 can be seen to be a distance shown by item 1118 from the middle of the entity's left foot.

It would therefore be desirable to adjust the steps of the entity in the key-frames preceding the kicking of the ball such that the entity approaches the ball and plants his foot aligned with the ball in the third key-frame 1132 of the animation.

The server therefore determines how much an animation displacement should be modified in order to achieve the desired sequence. This is then notified to the client, which then processes the animation accordingly. The amount of displacement should be limited to be within reasonable limits for any given animation so that the animation has an acceptable look and feel.

FIG. 11b shows how the animation may look once the required modification has been applied to the steps of the entity.

In the first key-frame 1128, the left foot 1102 of the entity has been modified such that it is now a distance 1120 ahead of item 1104. In the second key-frame 1130, the right foot 1106 of the entity has been modified such that it is now a distance 1122 ahead of item 1108. In the third key-frame 1132, the left foot 1110 of the entity has been modified such that it is now a distance 1124 ahead of item 1112. This produces the desired effect that the middle 1126 of the left foot 1110 of the entity and the ball 1100 are now aligned in the third key-frame 1132 when the ball is, or is about to be, kicked.

Without further action, the entity's feet would appear to slide across the terrain when playing the modified animation. For example, suppose a run animation naturally moves the player forwards by 1.5 metres, and a modification is applied to reduce the forward motion by 0.5 metres and add a sideways displacement of 0.25 metres. The player's feet will appear to slide across the ground as the modification is applied.

This problem may be solved by identifying the periods of the animation during which each foot is planted on the ground. Inverse leg kinematics may then be employed to adjust the leg movement of the entity, so that each foot remains planted during the same period. This may involve adjusting leg body-parts such as the thighs, knees, calves, ankles, feet, etc, of the entity into natural looking poses for the modified foot placement positions. The details of the mathematics and algorithms used to implement such inverse leg kinematics compensation will be clear to one skilled in the art and are not described here in detail.

Once the server has calculated that an animation modification should be applied to an animation or sequence of animations on one or more clients, the server may transmit data associated with the modifications to the relevant clients. The modifications may then be applied to entity tracking data corresponding to movement of the smoothed-movement bone on the server and possibly also on the client.

The above embodiments are to be understood as illustrative examples of the invention. Further embodiments of the invention are envisaged.

The above description describes calculating smoothed-movement bone data for the first and last key-frames of an animation and using this data to calculate smoothed-movement bone data for intermediate key-frames. In alternative embodiments, smoothed-movement bone data for key-frames other than the first and last key-frames of an animation may be calculated first, for example for intermediate key-frames, and used to produce smoothed-movement bone data for other key-frames including the first and last key-frames. In further alternative embodiments, no smoothing may be carried out and smoothed-movement bone data may be calculated for all key-frames individually.

Displacement modifications such as those depicted in exemplary FIGS. 11a and 11b may be applied over more or less than three key-frames in an animation, or even the whole animation. Displacement modifications may be applied linearly over such key-frames or non-linearly to produce more displacement in some key-frames than others. The displacement may also involve modifying the displacement of the entity in directions perpendicular to items 1104, 1108, and 1112 in FIGS. 11a and 11b.

Embodiments of the present invention which are described with reference to client-server based configurations may also be implemented in other configurations and vice versa.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A server-based method for controlling animation on a client of a user-controlled entity in a virtual environment, said user-control being client-based, said method comprising:
storing, on a server, first entity tracking data associated with tracking of a first entity in said virtual environment;
receiving, on said server from a first client, entity-control input data associated with user-control of said first entity in said virtual environment;
on the basis of said input data received from said first client, selecting, on said server, a first animation to be animated on said first client, said first animation to be animated on said first client being selected from a first plurality of animations;
transmitting, from said server to said first client, first data identifying said first selected animation of said first entity in said virtual environment;
retrieving one or more entity variation characteristics associated with said first selected animation to be animated on said first client; and
on the basis of said retrieved entity variation characteristics associated with said first selected animation to be animated on said first client, updating said stored first entity tracking data.

2. A method according to claim 1, comprising further selecting said first animation to be animated on said first client on the basis of said stored first entity tracking data.

3. A method according to claim 1, wherein said first stored entity tracking data comprises one or more of:
location data associated with tracking of a location of said first entity during a series of animations,
orientation data associated with tracking of an orientation of said first entity during a series of animations, and
timing data associated with tracking of a timing of said first entity during a series of animations.

4. A method according to claim 1, comprising:
selecting, on said server, an additional animation to be animated on said first client from said first plurality of animations;
transmitting, from said server to said first client, additional data identifying said additional animation to be animated on said first client;
retrieving one or more additional entity variation characteristics associated with said additional selected animation; and
on the basis of said retrieved additional entity variation characteristics, updating said stored first entity tracking data.

5. A method according to claim 4, wherein said first and said additional selected animations are selected for animation in sequence.

6. A method according to claim 1, wherein said plurality of animations is derived from motion-captured data.

7. A method according to claim 1, further comprising:
storing, on said server, second entity tracking data associated with tracking of a second entity in said virtual environment;
receiving, on said server from a second client, entity-control input data associated with user-control of said second entity in said virtual environment, said second client being remote from said first client;
on the basis of said input data received from said second client, selecting, on said server, a first animation to be animated on said second client, said first selected animation to be animated on said second client being selected from a second plurality of animations;
transmitting, from said server to said second client, data identifying said first selected animation to be animated on said second client in said virtual environment;
retrieving one or more entity variation characteristics associated with said first selected animation to be animated on said second client; and
on the basis of said retrieved entity variation characteristics associated with said first selected animation to be animated on said second client, updating said stored second entity tracking data.

8. A method according to claim 7, comprising further selecting said first animation to be animated on said second client on the basis of said stored second entity tracking data.

9. A method according to claim 1, wherein said retrieved variation characteristics are retrieved from memory storage on said server.

10. A method according to claim 7, wherein said first plurality and second plurality comprise one or more entity animations in common.

11. A method according to claim 7, wherein said selection of said animation in said first plurality is dependent on said selection of said animation in said second plurality if said first entity and said second entity are to interact in said virtual environment

12. A client-based method for movement animation on a client of a user-controlled entity in a virtual environment, said user-control being client-based, said method comprising:
storing animation data on a first client, said stored animation data comprising a first plurality of entity animations;
processing, on said first client, first entity tracking data associated with tracking of a first entity in a virtual environment;
transmitting entity-control input data from said first client to a server, said input data being associated with user-control of a first entity in said virtual environment;
receiving first data, on said first client from said server, said received first data comprising first selection data identifying an entity animation in said first plurality; and
animating said first entity in said virtual environment on said first client on the basis of said first received data, said animation data stored on said first client, and said first entity tracking data.

13. A method according to claim 12, comprising receiving, on said first client from said server, said first entity tracking data.

14. A method according to claim 12, comprising storing said first entity tracking data on said client,
wherein said processing of said entity tracking data comprises retrieving said entity tracking data from said store on said client.

15. A method according to claim 12, comprising:
processing, on said client, entity variation characteristics associated with said identified entity animation;
on the basis of said processed entity variation characteristics, updating said first entity tracking data; and
further animating said first entity in said virtual environment on said first client on the basis of said updated first entity tracking data.

16. A method according to claim 15, comprising receiving said entity variation characteristics on said client from said server.

17. A method according to claim 15, comprising storing said entity variation characteristics on said client,
wherein said processing of said entity variation characteristics comprises retrieving said entity variation characteristics from said store on said client.

18. A method according to claim 12, wherein said first entity tracking data comprises one or more of:
location data associated with tracking of a location of said first entity during a series of animations,
orientation data associated with tracking of an orientation of said first entity during a series of animations, and
timing data associated with tracking of a timing of said first entity during a series of animations.

19. A method according to claim 12, wherein said first received data comprises additional selection data identifying an additional entity animation in said first plurality, and said animating step comprises animating said identified animations in sequence.

20. A method according to claim 12, wherein said stored animation data is derived from motion-captured data.

21. A method according to claim 12, further comprising:
storing animation data on a second client, said second client being remote to said first client, said animation data stored on said second client comprising a second plurality of entity animations;
processing, on said second client, second entity tracking data associated with tracking of a second entity in a virtual environment;
transmitting entity-control input data from said second client to said server, said input data transmitted from said second client being associated with user-control of a second entity in said virtual environment;
receiving second data, on said second client from said server, said second received data comprising second selection data identifying an entity animation in said second plurality; and
animating said second entity in said virtual environment on said second client on the basis of said second received data, said animation data stored on said second client, and said second entity tracking data.

22. A method according to claim 21, wherein said first plurality and second plurality comprise one or more entity animations in common.

23. A method according to claim 21, wherein said identification of said animation in said first plurality is dependent on said identification of said animation in said second plurality if said first entity and said second entity are to interact in said virtual environment

24. A method for movement animation of a user-controlled entity in a virtual environment, said method comprising:
storing animation data derived from motion-captured data, said stored animation data comprising an entity movement animation, said entity movement animation including body-part movement data for individual body-parts of said entity;
receiving entity-control input data, said input data being associated with user-controlled movement of said entity in said virtual environment; and
animating said entity in said virtual environment according to said stored animation data in a third person perspective view, wherein the location and orientation of said third person perspective view is defined by at least some of said body-part movement data.

25. A method for movement animation of a user-controlled entity in a virtual environment, said method comprising:
storing animation data, said stored animation data including a plurality of entity movement animations, each of said entity movement animations having associated entity variation characteristics;
receiving entity-control input data, said input data being associated with user-controlled movement of said entity in said virtual environment;
on the basis of said input data, selecting an entity movement animation from said plurality and modifying said selected animation such that the entity variation characteristics associated with said selected animation are modified; and
animating said entity in said virtual environment according to said modified animation.

26. A computer-implemented multi-player sports game comprising animation performed over a data communications network according to claim 1 or 12, wherein each player controls one or more entities in said game over said network via a client.

27. Apparatus adapted to perform the method of claim 1 or 12.

28. A computer program product comprising a computer-readable medium having computer readable instructions recorded thereon, the computer readable instructions being operative, when performed by a computerised device, to cause the computerised device to perform the method of claim 1 or 12.
